(19) United States
(12) Patent Application Publication
(10) Pub. No.: US 2025/0217764 A1
(43) Pub. Date: Jul. 3, 2025

(54) PRODUCT INFORMATION MANAGEMENT SERVER, PRODUCT INFORMATION MANAGEMENT METHOD, AND RECORDING MEDIUM

(71) Applicant: Rakuten Group, Inc., Tokyo (JP)

(72) Inventors: Yuko Ikeda, Tokyo (JP); Kensaku Yoshida, Tokyo (JP); Kazunari Saito, Tokyo (JP); Takahiro Umeki, Tokyo (JP)

(73) Assignee: Rakuten Group, Inc., Tokyo (JP)

(21) Appl. No.: 18/991,880

(22) Filed: Dec. 23, 2024

(30) Foreign Application Priority Data
Dec. 28, 2023 (JP) 2023-223688

(51) Int. Cl. G06Q 10/087

(52) U.S. Cl. CPC G06Q 10/087

(57) ABSTRACT

Product information management server connectable via network to one or more terminals, having: an extractor that extracts, from a product information registration database in which detailed information containing outline information of an item are registered, pieces of the outline information; a specifier that, when a first piece of the outline information in a first piece of the detailed information corresponding to a first item matches a second piece of outline information in a second piece of detailed information corresponding to a second item, specifies a different portion that differentiates the first piece of detailed information and the second piece of detailed information; and a list presenter that outputs, to at least one terminal, second difference information together with a list of the extracted pieces of outline information, the second difference information being information of the different portion in the second piece of detailed information.

### CROSS-REFERENCE TO RELATED APPLICATIONS

This application claims the benefit of Japanese Patent Application No. 2023-223688, filed on Dec. 28, 2023, the entire disclosure of which is incorporated by reference herein.

### FIELD OF THE INVENTION

The present disclosure relates to a product information management server, a product information management method, and a recording medium.

### BACKGROUND OF THE INVENTION

In an electronic marketplace, a seller who lists products views a list indicating outline of sales information, such as product names and model numbers (for example, Patent Literature 1: Unexamined Japanese Patent Application Kokai Publication No. 2022-181385), and performs processing such as selecting and editing desired sales information, making new sales information that is a copy of selected existing sales information and then editing content of the copied sales information (or the existing sales information), or the like, to thereby manage items to be listed.

### SUMMARY OF THE INVENTION

### Technical Problem

The seller may make a schedule, for a certain item, for selling at different selling periods with different stock quantities at different prices. In this case, by preparing in advance multiple pieces of sales information that are each a piece of information for selling an item, that are the same in basic content and that differ only in some portions, the seller can perform quick and easy switching of the sales information of this item by causing only one of the multiple pieces of the sales information to be enabled while causing the other to be disabled.

A new piece of the sales information that is a copy of a piece of the sales information is the same in basic content as the piece of the sales information, such as in a product name or a model number. This produces difficulty in distinguishing these pieces in a list, thereby creating the problem of making it difficult to quickly select from the list the sales information of a desired item.

The present disclosure is made to solve the aforementioned problems, and an objective of the present disclosure is to present multiple items that are the same in basic content and that differ only in some portions in a manner that enables easy distinction of these items in a list.

### Solution to Problem

Among the embodiments disclosed in the present application, a summary of the representative one is simply described as below. A product information management server according to the present embodiment is a product information management server connectable via a network to one or more terminals, the product information management server including:
at least one processor,
in which the at least one processor is configured to
   extract, from a product information registration database in which a plurality of pieces of detailed information each containing a piece of outline information of an item are registered, a plurality of pieces of the outline information,
   when a first piece of the outline information in a first piece of the detailed information corresponding to a first item matches a second piece of the outline information in a second piece of the detailed information corresponding to a second item, specify a different portion that differentiates the first piece of the detailed information and the second piece of the detailed information, and
   output, to at least one terminal of the one or more terminals, second difference information together with a list of listing the extracted plurality of pieces of the outline information, the second difference information being information of the different portion in the second piece of the detailed information.

### Advantageous Effects of Invention

The present disclosure enables presenting multiple items that are the same in basic content and that differ only in some portions in a manner that enables easy distinction of these items in a list.

### BRIEF DESCRIPTION OF DRAWINGS

A more complete understanding of this application can be obtained when the following detailed description is considered in conjunction with the following drawings, in which:

FIG. 1 is an explanatory diagram illustrating cooperation between a product information management server and other devices according to an embodiment;

FIG. 2 is an explanatory diagram illustrating functional configuration of the product information management server according to the embodiment;

FIG. 3 is an explanatory diagram illustrating an example of product information records according to the embodiment;

FIG. 4 is a sequence diagram illustrating a manner of communication between the product information management server and a terminal;

FIG. 5 is an explanatory diagram illustrating an example of a list display screen according to the embodiment;

FIG. 6 is an explanatory diagram illustrating an example of an item information registration screen according to the embodiment;

FIG. 7 is an explanatory diagram illustrating an example of the list display screen according to the embodiment;

FIG. 8 is an explanatory diagram illustrating an example of an edit screen according to the embodiment;

FIG. 9 is an explanatory diagram illustrating an example of the list display screen according to the embodiment;

FIG. 10 is an explanatory diagram illustrating an example of the copy screen according to the embodiment;

FIG. 11 is an explanatory diagram illustrating an example of the list display screen according to the embodiment;

FIG. 12 is a flowchart for explanation of a flow of product information management processing according to the embodiment;

FIG. 13A is an explanatory diagram illustrating an example of the product information records according to the embodiment;

FIG. 13B is an explanatory diagram illustrating an example of a list according to the embodiment;

FIG. 14 is an explanatory diagram illustrating an example of the list display screen according to the embodiment;

FIG. 15 is an explanatory diagram illustrating an example of the list display screen according to the embodiment;

FIG. 16 is an explanatory diagram illustrating an example of the list display screen according to the embodiment;

FIG. 17 is an explanatory diagram illustrating an example of the list display screen according to the embodiment;

FIG. 18 is an explanatory diagram illustrating an example of the list display screen according to the embodiment;

FIG. 19 is an explanatory diagram illustrating an example of the list display screen according to the embodiment; and

FIG. 20 is an explanatory diagram illustrating an example of the list display screen according to the embodiment.

### DETAILED DESCRIPTION OF THE INVENTION

### Relationship Between Product Information Management Server, Terminal, and Program

A product information management server according to the present embodiment includes one or more server devices. The product information management server manages information that relates to items managed by a user of a terminal such as a smartphone, a tablet computer, or a personal computer and that is hereinafter referred to as the “product information”. The product information management server presents a list of items in accordance with user operation, and performs registration, editing, and the like of the product information, and other related operations.

The product information management server according to the present embodiment can be used, for example, to provide sellers entered or entering an electronic marketplace with means for managing the items for sale.

Although one general way to achieve the product information management server according to the present embodiment is to cause a computer to execute a program, the product information management server may be achieved by causing a dedicated electronic circuit to executed processing.

Alternatively, as an intermediate configuration of the computer and the dedicated electronic circuit, the product information management server according to the present embodiment may be configured by applying a technique of, for example, a field programmable gate array (FPGA) for dynamic configuration of an electronic circuit on the basis of a design script of the electronic circuit into which the program is compiled.

The product information management server according to the present embodiment is achieved by execution, by one or more server computers that communicate with terminals accessible to a product information management site provided by the product information management server, of various functions achieved by one or more server programs.

The terminals according to the present embodiment are each a terminal computer that achieves a smartphone or the like, and can be achieved by execution of a terminal program provided from a provider or an administrator via a distribution server or the like.

The terminal program may be a program equivalent to a so-called “application (app)”. The terminal program may also be incorporated into other applications, such as applications for providing Internet sales services.

Additionally, a general browser can be used as the terminal program, or a script program that runs on a browser can also be used as the terminal program.

In these cases, the application or browser operating in the terminal computer communicates with the product information management server that functions as an application server or web server, and thereby serves as an interface for providing a product information management service with a user.

In general, the program to be executed by the server computer or the terminal computer can be recorded in a non-transitory computer-readable information recording medium, such as compact disk, flexible disk, hard disk, optical magnetic disk, digital video disk, magnetic tape, read only memory (ROM), electrically erasable programmable ROM (EEPROM), flash memory, or semiconductor memory. This non-transitory information recording medium can be distributed or sold separate from the server computers.

In the server computer or the terminal computer, the program recorded in a non-transitory information recording medium, such as flash memory or hard disk, is loaded into a random access memory (RAM) that is a temporary storage, and then the instructions contained in the loaded program are executed by a central processing unit (CPU). In contrast, in an architecture in which the ROM and the RAM can be mapped and executed in a single memory space, the instructions contained in the program stored in the ROM are directly loaded and executed by the CPU.

The server program or the terminal program may be distributed or sold, for example, from a distribution server managed by the provider or administrator to the server computer or the terminal computer via a temporary transmission medium, such as computer communication network, independently from the computer to execute the program.

Note that, when the product information management server includes multiple computers, the programs running on these computers are multiple mutually different server programs that cooperate with each other while having mutually different functions. These programs in combination can thus be deemed as a system program for achieving the product information management server.

In the present embodiment, the product information management server is taken to provide an electronic marketplace and provide means for presenting a list of pieces of item information that is information of items listed in the electronic marketplace, registering and editing the item information, and performing other related operations.

### Overall Configuration

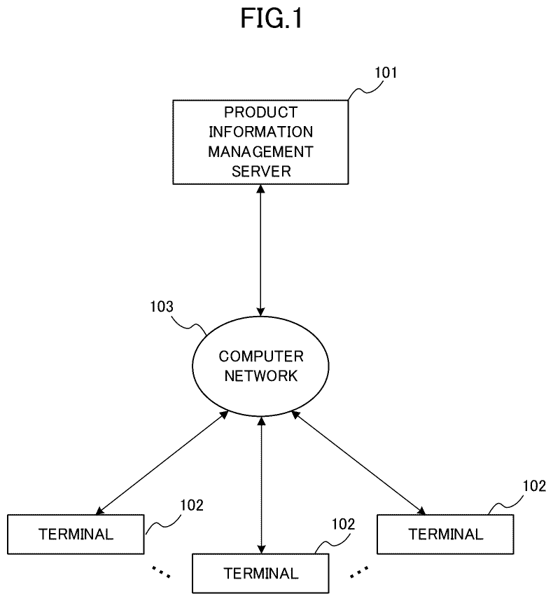

FIG. 1 is an explanatory diagram illustrating cooperation between a product information management server 101 and other devices. Hereinafter, a description is made with reference to this drawing.

The product information management server 101 is connected to one or more terminals 102 via a computer communication network 103, such as the Internet. The product information management server 101 and the one or more terminals 102 may be connected with various networks established by a communication line or the like.

The product information management server 101 is operated by the provider or administrator of the electronic marketplace and provides, via the computer communication network 103, means for managing item information that is information relating to items listed by a user who is a seller who uses the terminal 102. The item information is information of, for example, product name, model number, selling price, stock quantity, sales period, color, size, and the like.

The terminal 102 is a terminal used by a user who lists items in the electronic marketplace provided by the product information management server 101. The user performs, using the terminal 102, operations for presenting a list of pieces of the item information relating to the self-listed items, registering and editing the item information, and performing other related processes.

### Functional Configuration of Product Information Management Server

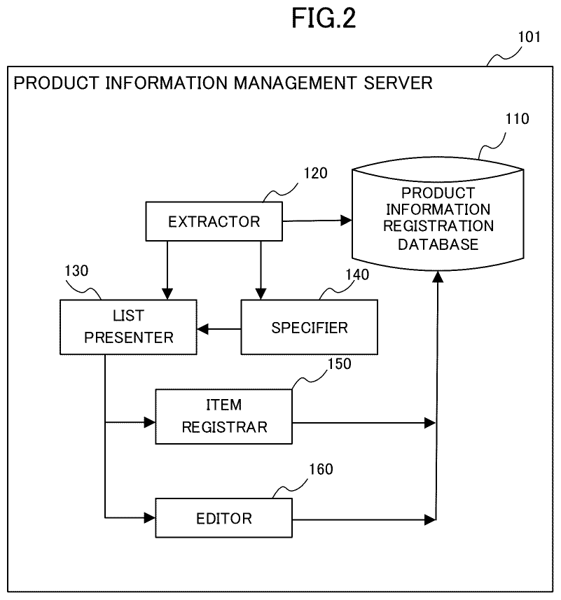

FIG. 2 is an explanatory diagram illustrating functional configuration of the product information management server 101. The product information management server 101 includes a product information registration database (DB) 110, an extractor 120, a list presenter 130, a specifier 140, an item registrar 150, and an editor 160.

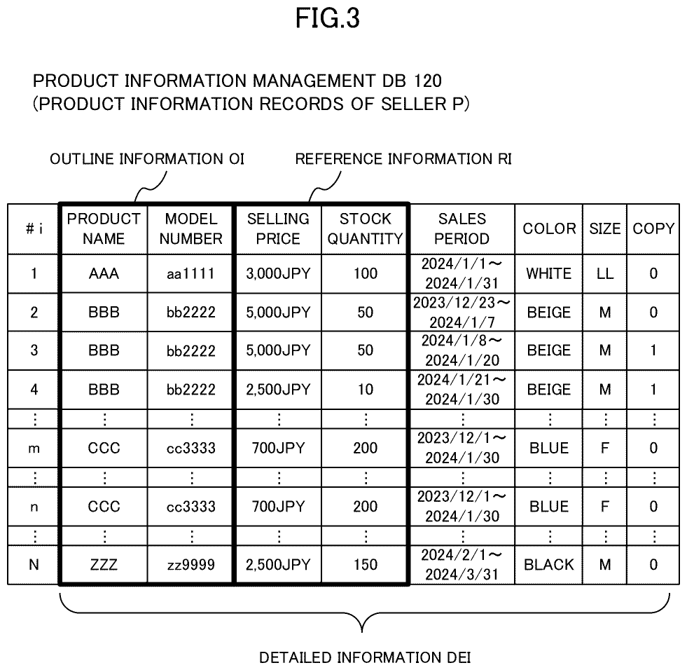

The product information registration DB 110 is a database in which, for each user who lists items in the electronic marketplace, detailed information of the items managed by the user is registered. The phase “for each user” herein encompasses “for each store that lists items”. FIG. 3 is an example of product information records relating to items managed by a seller P. Each piece of the item information contains entries for row number (#i), product name, model number, selling price, stock quantity, sales period, color, size, and copy flag. In this example, N products managed by the seller P are taken to be registered in the product information registration DB 110. The copy flag is an example of copy state information. The product information registration DB 110 may associate identification information of a user with the detailed information of items.

The row number is a number assigned to each row of the product information records, in an order in which items are sorted according to predetermined criteria. The phrase “sort according to predetermined criteria” herein indicates sorting for each entry in order of the Japanese syllabary, in alphabetical order, or numerical order, and the criteria may be set by the user. The copy flag is a flag indicating that being a piece of the item information registered by copying other piece of the item information in an editing operation by the user. A piece of the item information that is newly registered is assigned the copy flag “0”, and a piece of the item information that is a copy of other piece of the item information is assigned the copy flag “1”.

In the present embodiment, content of the entries of each piece of the item information in the product information records is referred to as a piece of the detailed information DEI. For example, a piece of the detailed information DEI is a portion of each of the product information records other than the row number, as illustrated in FIG. 3. The piece of the detailed information DEI may be the entire each product information record. In one example, the product information registration DB 110 may be a database that does not store row numbers. In the case of this example, the configuration may be used in which the product information management server 101 performs a search for multiple pieces of the detailed information DEI within the product information registration DB 110, performs sorting based on predetermined portions of the searched pieces of the detailed information DEI, assigns row numbers to a result of the sorting, and outputs to the terminal 102 the result with the row numbers assigned. Additionally, a predetermined portion of each piece of the item information that indicates an outline of the corresponding item, such as the product name and model number, is referred to as a piece of outline information OI, and the other predetermined portion that serves as a reference for determination by the user on content of the corresponding item such as the selling price and stock quantity, is referred to as a piece of reference information RI. A piece of the outline information OI is information that enables specifying a product. For example, a piece of the outline information OI is information specifying a target of purchase. A piece of the reference information RI is information that enables specifying characteristics of a product. A piece of the reference information RI can also be said as information indicating a management condition of a product. For example, a piece of the reference information RI is information that specifies, among information indicating the characteristics of the target of purchase, characteristics that are variable depending on a selling period, such as the selling price and stock quantity.

Again with reference to FIG. 2, the extractor 120 extracts, from each of pieces of the detailed information DEI corresponding to multiple items registered in the product information registration DB 110, a predetermined portion of the piece of the detailed information DEI, and uses as a piece of the outline information OI. The extractor 120 extracts the product name or model number as the predetermined portion and uses as the piece of the outline information OI. The extractor 120 further extracts, from each of the pieces of the detailed information DEI corresponding to multiple items registered in the product information registration DB 110, the other predetermined portion of the piece of the detailed information DEI, and uses as a piece of the reference information RI. The extractor 120 extracts the selling price and stock quantity as the other predetermined portion and uses as the piece of the reference information RI. The entries to be extracted as the piece of the outline information OI and the piece of the reference information RI are taken to be set in advance by operation of the user or the like.

The list presenter 130 outputs, to the terminal 102, a list of listing multiple pieces of the outline information OI extracted by the extractor 120. For example, the list presenter 130 presents to the user the list of listing multiple pieces of the outline information OI extracted by the extractor 120 via the terminal 102. Additionally, in the case where multiple pieces of the detailed information contain the same piece of the outline information OI, the list presenter 130 outputs information of a difference or the like. The details of this function are described below.

In the case where a first piece of the outline information extracted from a first piece of the detailed information corresponding to a first item among multiple items in the product information records matches a second piece of the outline information extracted from a second piece of the detailed information corresponding to a second item among the multiple items, the specifier 140 specifies a different portion that differentiates the first piece of the detailed information and the second piece of the detailed information.

The item registrar 150 receives, via the terminal 102, an operation from the user for registering information of a new item in the product information records.

The editor 160 receives, via the terminal 102, an operation from the user for editing the detailed information DEI of the item information contained in the product information records. Additionally, the editor 160 receives an operation from the user for copying the item information contained in the product information records.

### Communication Between Product Information Management Server and Terminal

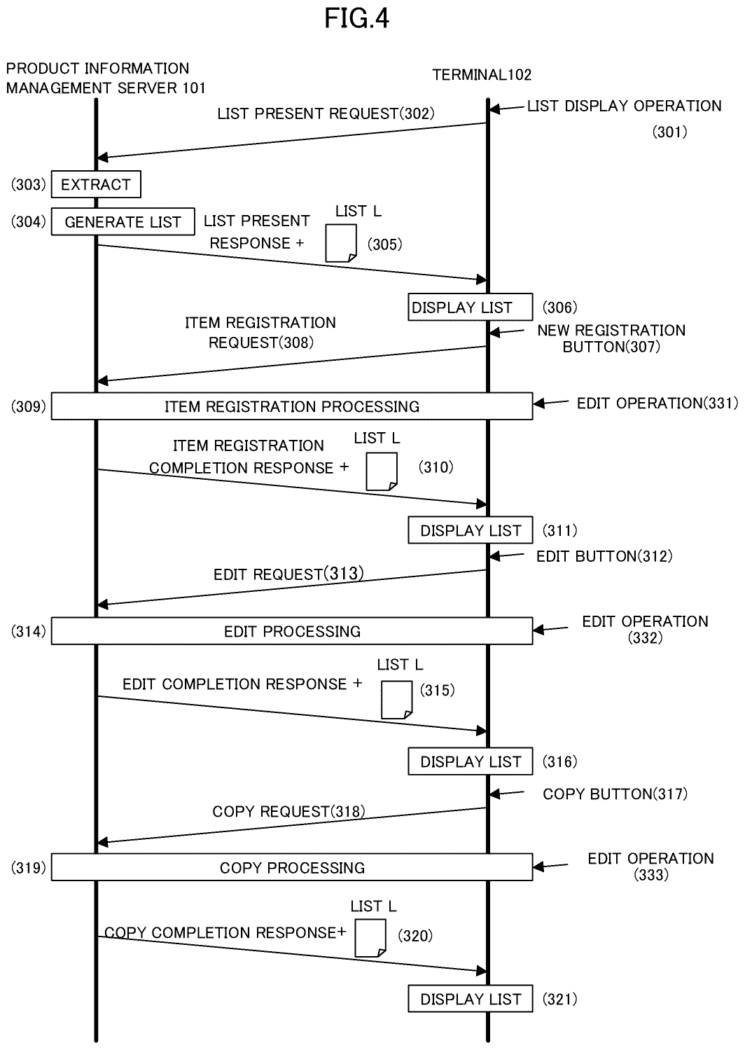

FIG. 4 is a sequence diagram illustrating a manner of communication between the product information management server 101 and the terminal 102. Hereinafter, an outline of the communication between the product information management server 101 and the terminal 102 is described with reference to FIG. 4.

First, upon a user performing a list display operation for displaying a list of items managed by the user (301), the terminal 102 transmits, to the product information management server 101, a list present request in which identification information that is information for identification of the user is specified (302). The identification information of the user of the terminal 102 is taken to be similarly transmitted in the processing described below for sending a request from the terminal 102 to the product information management server 101.

Upon receiving the list present request from the terminal 102, the product information management server 101 accesses the product information registration DB 110 and references the product information records of the user corresponding to the information specified in the list present request. Then the extractor 120 extracts pieces of the outline information OI and pieces of the reference information RI from the product information records of the user (303).

Thereafter, the list presenter 130 generates a list L of listing the pieces of the outline information OI and the pieces of the reference information RI extracted by the extractor 120 (304), and transmits, to the terminal 102, a list present response in which the list L is specified (305).

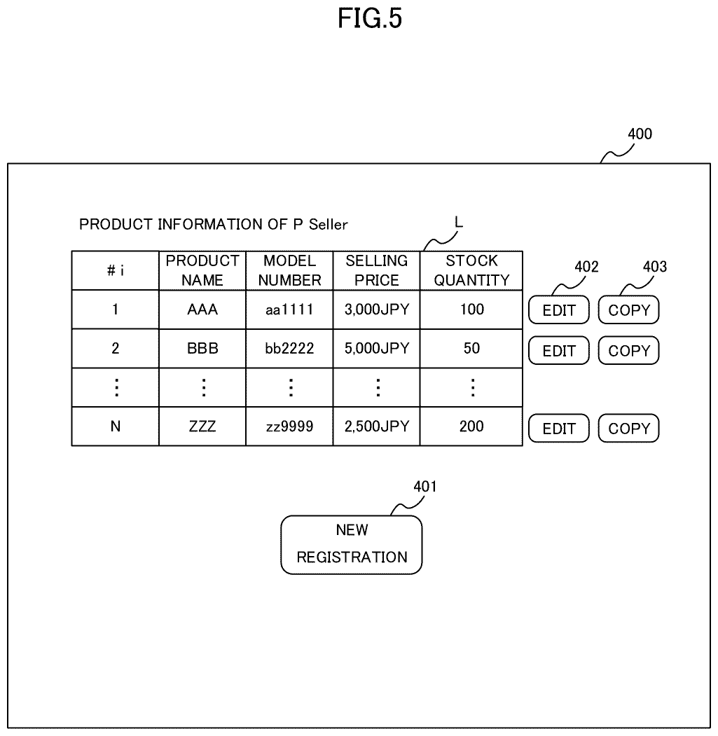

Upon receiving the list present response, the terminal 102 displays the list L specified in the list present response (306). FIG. 5 illustrates an example of a list display screen 400 displayed by the terminal 102. In the list display screen 400, the list L, a new registration button 401, an edit button 402, and a copy button 403, are displayed. The edit button 402 and the copy button 403 are displayed outside the list L on the right of each piece of the item information.

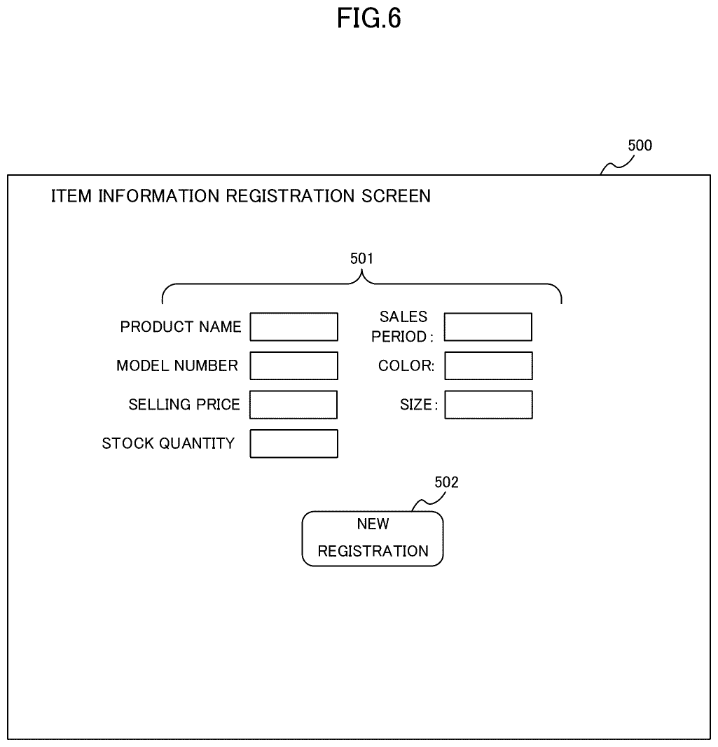

Again with reference to FIG. 4, when the user selects the new registration button 401 in this state (307), the terminal 102 transmits, to the product information management server 101, an item registration request for newly registering a piece of the item information (308). Upon the product information management server 101 receiving the item registration request, item registration processing is started (309), and the terminal 102 displays an item information registration screen 500, such as the screen illustrated in FIG. 6. In the item information registration screen 500, an entry field 501 for entry of pieces of the detailed information DEI and a registration button 502 are displayed. When the user edits the entry field 501 (331) and selects the registration button 502, a piece of the item information is registered, and the item registration processing ends.

Then the product information management server 101 transmits, to the terminal 102, an item registration completion response in which the list L with an item registered is specified after completing item registration (310). Upon receiving the item registration completion response, the terminal 102 displays the list L specified in the item registration completion response (311). This list L contains the piece of the item information that is newly registered.

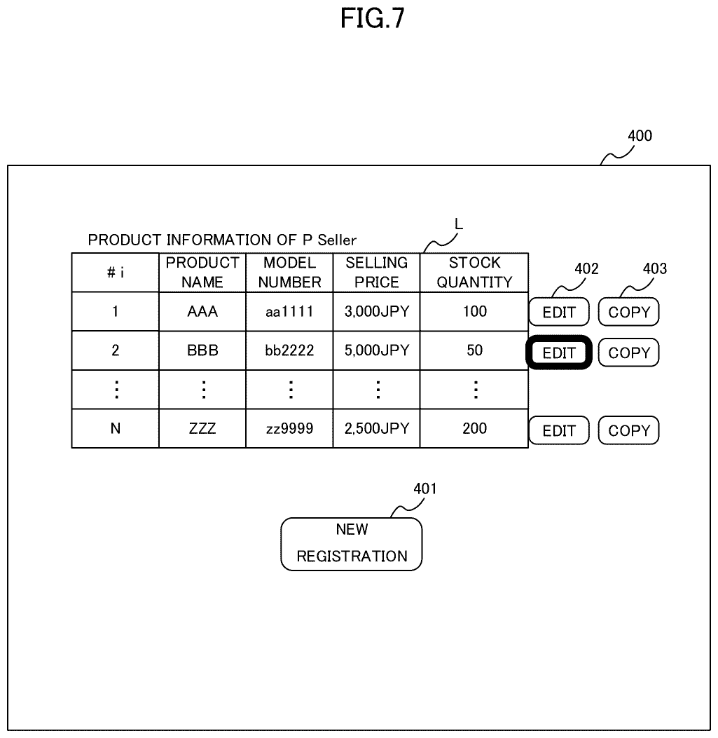

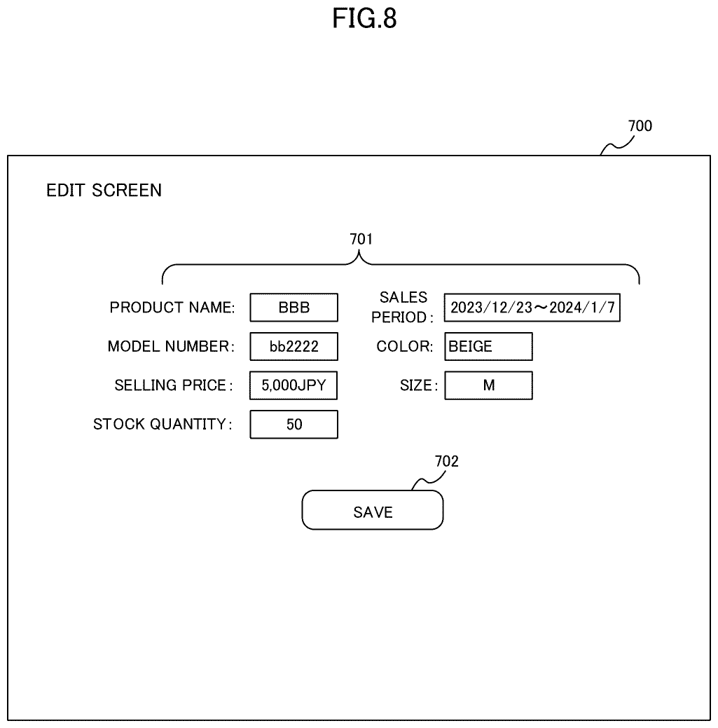

Thereafter, when the user selects the edit button 402 corresponding to row number 2 as illustrated in FIG. 7 (312), the terminal 102 transmits, to the product information management server 101, an edit request for editing the piece of the item information (313). Upon the product information management server 101 receiving the edit request, edit processing is started (314), and the terminal 102 displays an edit screen 700, such as the screen illustrated in FIG. 8. The edit screen 700 is a screen for editing the piece of the detailed information DEI of row number 2. When the user edits the entry field 701 (332) and selects the save button 702, the edited piece of the item information is registered, and the edit processing ends.

Then the product information management server 101 transmits, to the terminal 102, an edit completion response in which the list L that has undergone the editing is specified (315). Upon receiving the edit completion response, the terminal 102 displays the list L specified in the edit completion response (316). This list L contains the piece of the item information that has undergone the editing.

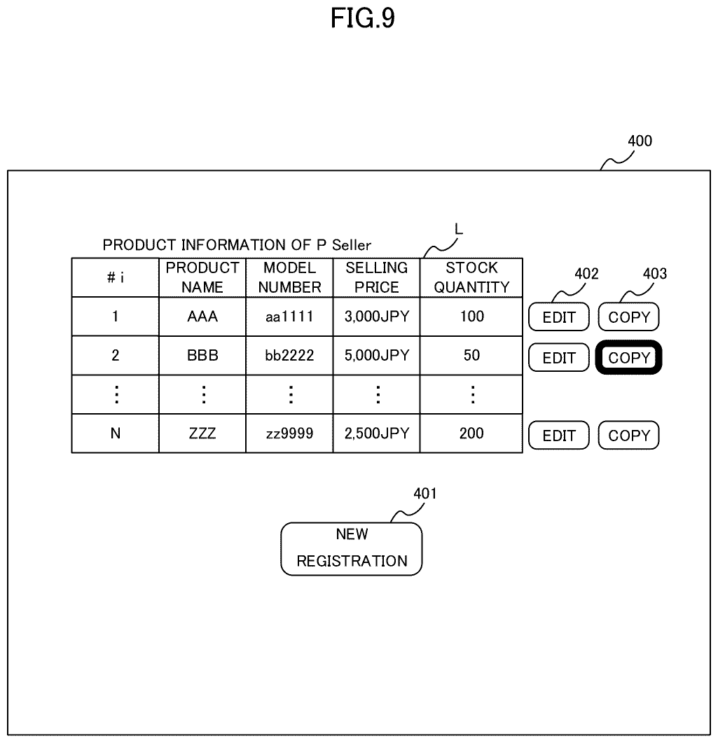

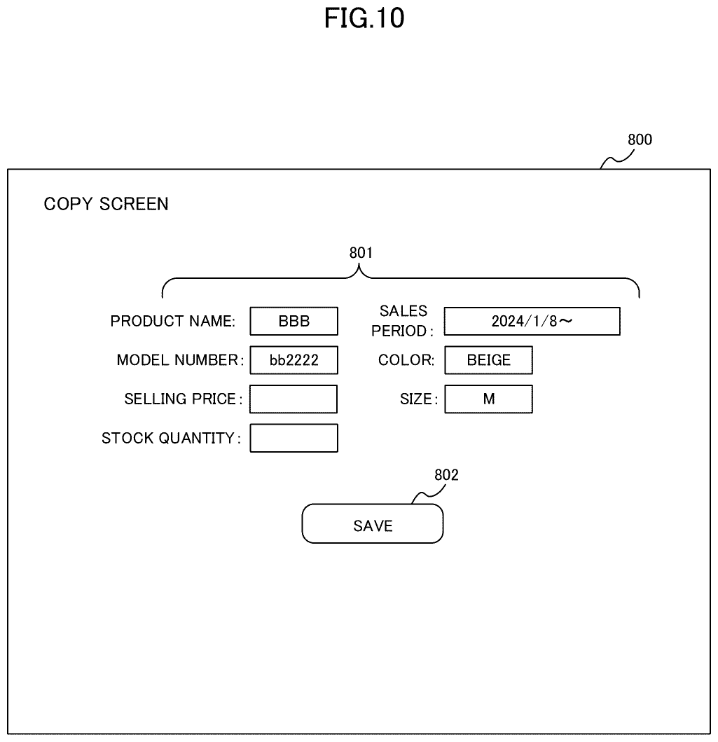

Thereafter, when the user selects the copy button 403 corresponding to row number 2 as illustrated in FIG. 9 (317), the terminal 102 transmits, to the product information management server 101, a copy request for copying the piece of the item information (318). Upon the product information management server 101 receiving the copy request, copy processing is started (319), and the terminal 102 displays a copy screen 800, such as the screen illustrated in FIG. 10.

The copy screen 800 is a screen for editing the piece of the item information of row number 2. A part of the entry field 801 of the copy screen 800, such as the field of the selling price and stock quantity, may be blank. Additionally, a commencement time of the sales period may be designated to the day after the termination time of the sales period of the original item (in this example, from Dec. 23, 2023 to Jan. 7, 2024), that is, designated to Jan. 8, 2024, without designation of a termination time. Leaving an entry that tends to be edited after the copy operation to be blank and designating predetermined content as described above enable improvement in user convenience. For the entry that tends to be edited after the copy operation, information of the original from which a copy is generated may be displayed in a separate field within the copy screen as information as a reference for editing.

When the user edits the entry field 801 (333) and selects the save button 802, the piece of the item information as a generated copy is registered, and the copy processing ends. The editor 160 sets the copy flag of the piece of the item information as the generated copy to “1” and registers in the product information registration DB 110. Then the product information management server 101 transmits, to the terminal 102, a copy completion response in which the list L with the piece of the item information as the generated copy added is specified (320).

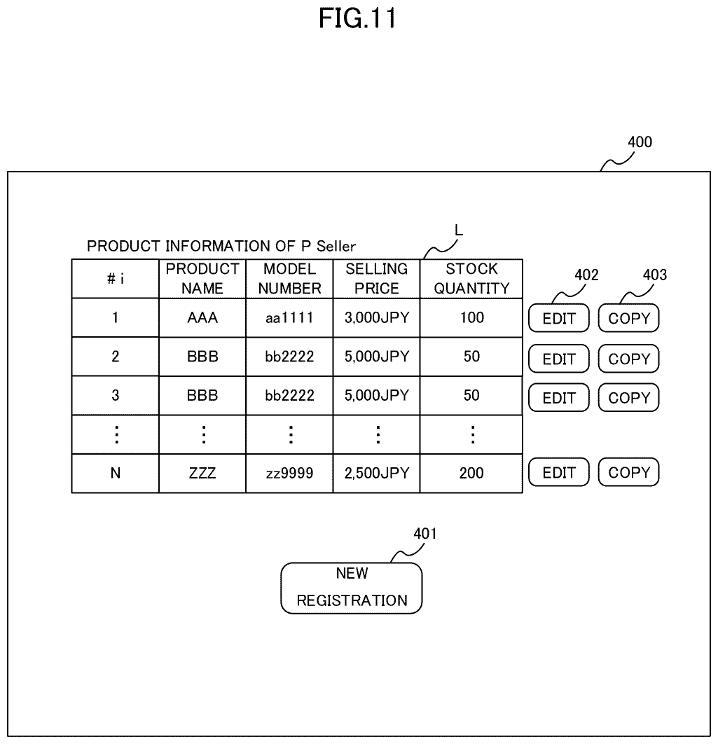

Upon receiving the copy completion response, the terminal 102 displays the list L specified in the copy completion response (321). As illustrated in FIG. 11, this list L contains the piece of the item information as the generated copy (row number 3) just below the piece of the item information from which the copy is generated (row number 2). Although FIG. 11 illustrates an example that makes it difficult to quickly distinguish (i.e., grasp the difference between) the item of row number 2 and the item of row number 3, a contrivance is made in the present embodiment that enables easily distinguishing the item as a generated copy and the item from which the copy is generated. The details of this contrivance are described below.

### Product Information Management Processing

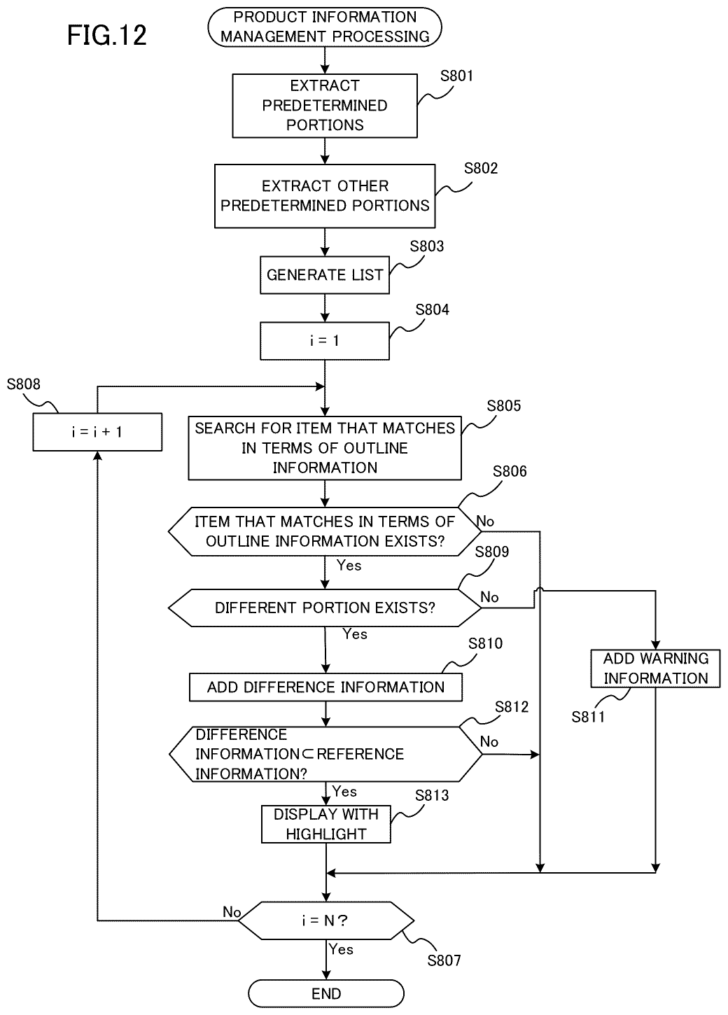

FIG. 12 is a flowchart for describing a flow of product information management processing executed by the product information management server 101 in the present embodiment. The product information management server 101 presents the list L of listing multiple items to the user via the terminal 102, in a manner that enables easily distinguishing a difference between similar items listed in the list L. Hereinafter, a description is given with reference to FIG. 12.

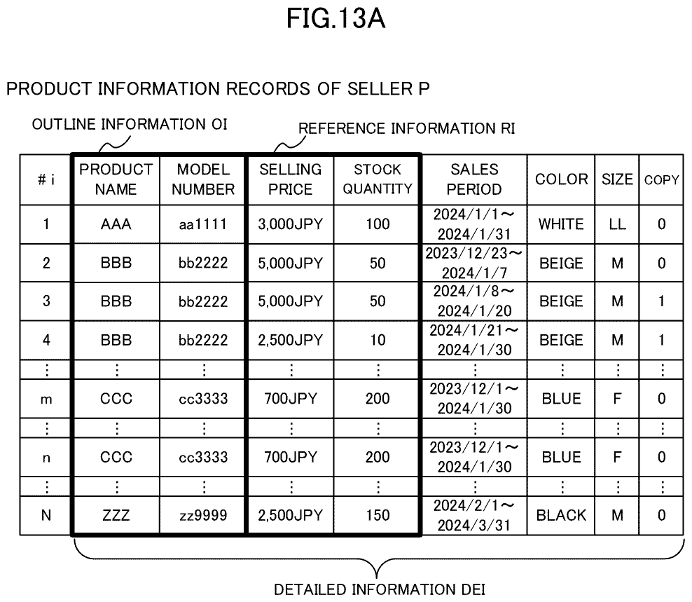

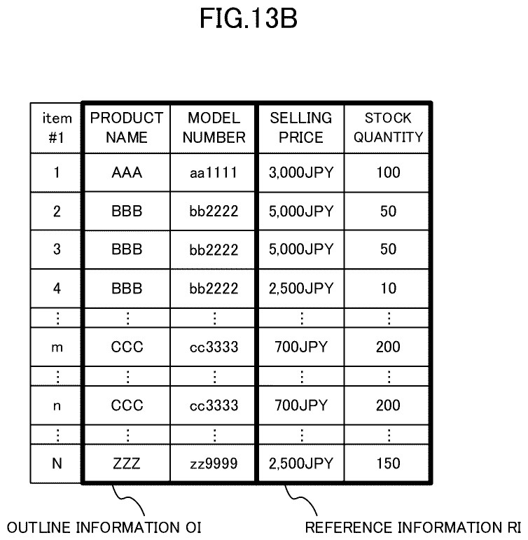

The product information management processing is started upon the product information management server 101 receiving, from the terminal 102 used by the seller P as the user, the list present request in which information for specifying the user (that is similar to the identification information for identification of the user) is specified. Upon the product information management processing is started, the extractor 120 accesses the product information registration DB 110 and references the product information records of the seller P, such as the records as illustrated in FIG. 13A. The extractor 120 firstly extracts the product name and model number that are the predetermined portions (step S801). In this example, the extracted predetermined portions are referred to as pieces of the outline information OI.

Thereafter, the extractor 120 extracts, from each of pieces of the detailed information DEI of multiple pieces of the item information registered in the product information registration DB110, the other predetermined portions (step S802). In this example, the extractor 120 is taken to extract the selling price and stock quantity as the other predetermined portions and uses as the piece of the reference information RI. The extractor 120 may simultaneously extract the pieces of the outline information OI and the pieces of the reference information RI.

Then the list presenter 130 generates a list of listing the extracted pieces of the outline information OI and pieces of the reference information RI, such as the list illustrated in FIG. 13B (step S803). That is, the list presenter 130 presents a list in which each piece of the outline information OI is associated with a piece of the reference information RI extracted from a piece of the detailed information DEI from which the piece of the outline information OI is extracted. Thereafter, the list presenter 130 sets row number i for a row as a comparison target to “1” (step S804).

Thereafter, the specifier 140 conducts, within the generated list, a search for a piece of the item information that matches, in terms of the piece of the outline information OI, the piece of the item information of row number i=1 as a comparative criterion (step S805), and determines whether a piece of the item information (corresponding to the “second item”) exists that matches, in terms of the piece of the outline information OI, the piece of the item information of row number i=1 as the comparative criterion (corresponding to the “first item”) (step S806). That is, the specifier 140 determines whether the first piece of the outline information OI extracted from the first piece of the detailed information DEI corresponding to the first item matches the second piece of the outline information OI extracted from the second piece of the detailed information DEI corresponding to the second item.

When the specifier 140 determines that a piece of the item information does not exist that matches the piece of the item information of row number i=1 as the comparative criterion in terms of the piece of the outline information OI (NO in step S806), the product information management server 101 determines whether the piece of the item information for which calculation is currently performed is the last piece of the item information, that is, determines whether row number i satisfies i=N (step S807). Since the piece of the item information for which calculation is currently performed is the piece of the item information of row number i=1, the product information management server 101 determines that row number i as the comparative criterion does not satisfy i=N (NO in step S807), and increments row number i as the comparative criterion (step S808). Thereafter, the processing shifts to step S805.

Here, in the case where one of two pieces of the detailed information DEI that match in terms of the piece of the outline information OI extracted by the extractor 120 is due to a copy of the other of the two pieces the detailed information DEI, the specifier 140 may use the other as the first piece of the detailed information DEI and use the one as the second piece of the detailed information DEI. That is, of the pieces of the detailed information DEI that match in terms of the piece of the outline information OI, the specifier 140 may use the one with the copy flag “0” as the first piece of the detailed information DEI and use the one with the copy flag “1” as the second piece of the detailed information DEI.

Conversely, when determining that a piece of the item information (corresponding to the “second item”) exits that matches the piece of the item information of row number i=1 as the comparative criterion (corresponding to the “first item”) in terms of the piece of the outline information OI (YES in step S806), the specifier 140 determines whether a different portion exists between the two pieces of the detailed information DEI of the two pieces of the item information (step S809). That is, the specifier 140 determines whether a different portion exists between the first piece of the detailed information DEI corresponding to the first item and the second piece of the detailed information DEI corresponding to the second item.

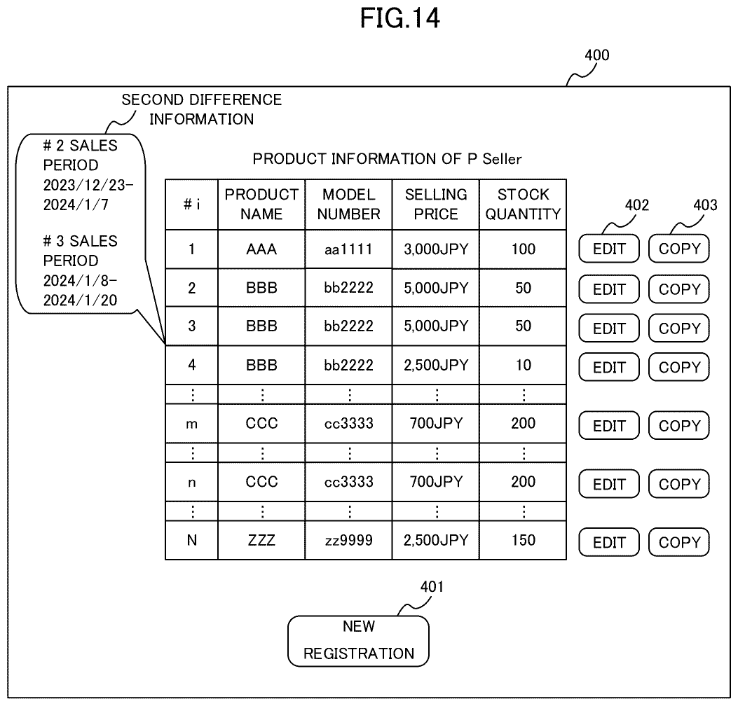

When the specifier 140 determines that the different portion exists between pieces of the detailed information DEI of the two pieces of item information (YES in step S809), the list presenter 130 adds difference information DII (step S810). The list presenter 130 presents, together with the second piece of the outline information OI listed in the list, second difference information DII relating to the different portion of the second piece of the detailed information DEI. For example, in the case of the list display screen 400 illustrated in FIG. 14, on the left of the product name of the piece of the item information of row number 3 (corresponding to the “second item”) generated by copying the piece of the item information of row number 2 (corresponding to the “first item”), the second difference information DII indicating a difference in the sales period is presented. For a piece of the item information that is a generated copy, the second difference information DII may indicate that being a copy. Furthermore, information specifying the piece of the item information from which a copy is generated may be added.

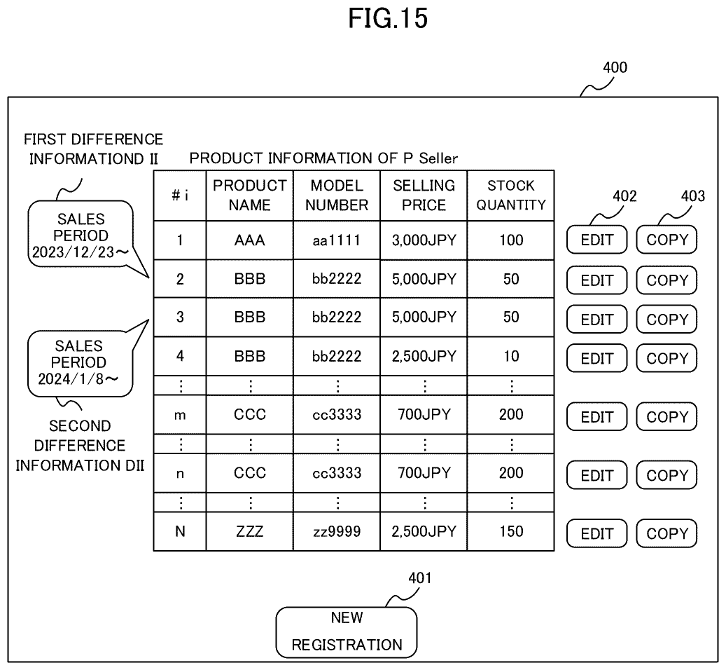

Furthermore, the list presenter 130 may present, together with the first piece of the outline information OI listed in the list, first difference information DII relating to the different portion of the first piece of the detailed information DEI. FIG. 15 illustrates the list display screen 400 according to this example, in which the second difference information DII is presented together with the piece of the item information of row number 3 corresponding to the second item, and the first difference information DII is presented on the left of the product name of the item of row number 2 corresponding to the first item. The first difference information DII may indicate the sales period of the first item, and the second difference information DII may indicate the sales period of the second item.

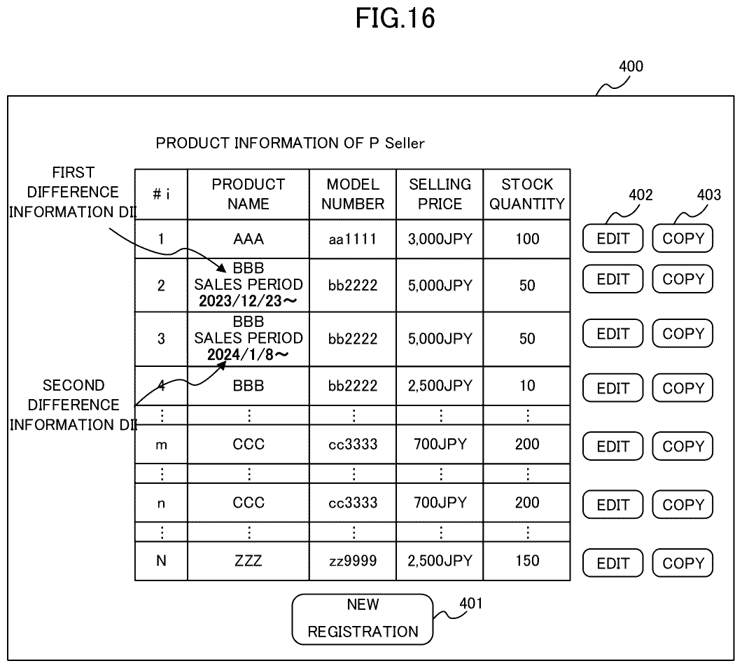

Furthermore, the list presenter 130 may display the first difference information DII and the second difference information DII within the fields of the product names that are the pieces of the outline information OI, as illustrated in FIG. 16.

Again with reference to FIG. 12, conversely, when the specifier 140 determines that the different portion does not exist between the pieces of the detailed information DEI of the two pieces of the item information (NO in step S809), the list presenter 130 adds warning information WI (step S810). That is, in the case where the different portion is unspecifiable by the specifier 140, the list presenter 130 presents first warning information WI together with the first piece of the outline information OI, and presents second warning information WI together with the second piece of the outline information OI.

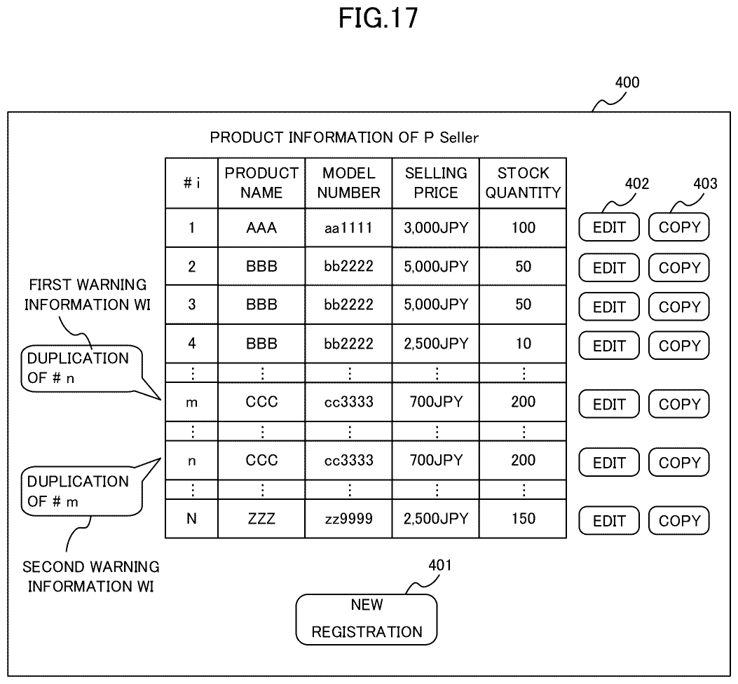

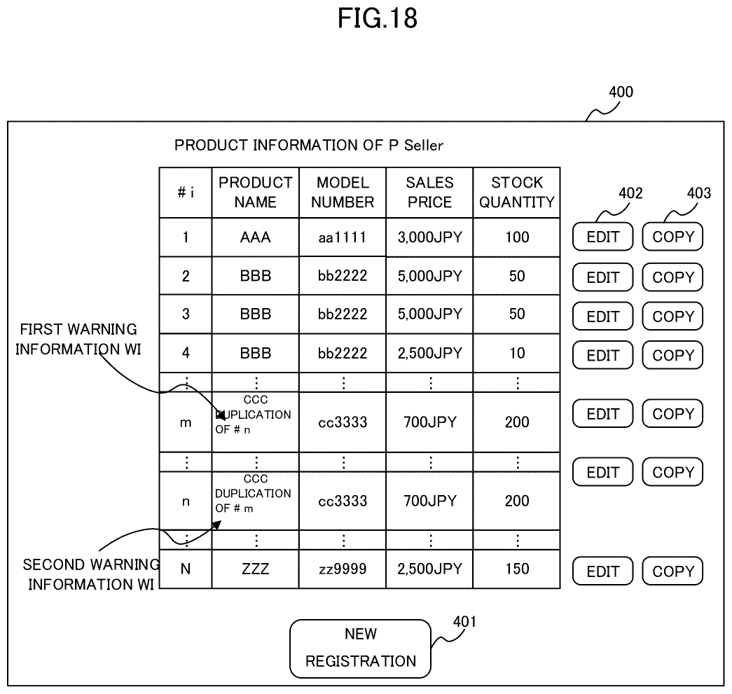

FIG. 17 illustrates an example of the list display screen 400 in the case where the different portion is unspecifiable by the specifier 140 between the piece of the detailed information DEI of the piece of the item information corresponding to row m and the piece of the detailed information DEI of the piece of the item information corresponding to row n. In the case where the first piece of the outline information is listed in the m-th row of the list and the second piece of the outline information is listed in the n-th row of the list, the list presenter 130 may indicate in the first warning information WI that being identical in content to the piece of the n-th item information and indicate in the second warning information WI that being identical in content to the piece of the m-th item information. Furthermore, as illustrated in FIG. 18, the list presenter 130 may cause each of the first warning information WI and the second warning information WI to be displayed in the field of the corresponding product name. Thereafter, the processing proceeds to step S807.

Again with reference to FIG. 12, then the specifier 140 determines whether the difference information DII is contained in any piece of the reference information RI (step S812). Upon the specifier 140 determining that the difference information DII is contained in a piece of the reference information RI (YES in step S812), the list presenter 130 highlights the difference information (step S813). That is, in the case where the second difference information DII is contained in a second piece of the reference information RI extracted from the second piece of the detailed information DEI, the list presenter 130 highlights in the list the second difference information DII contained in the second piece of the reference information RI and thereby presents the second difference information DII together with the second piece of the outline information OI.

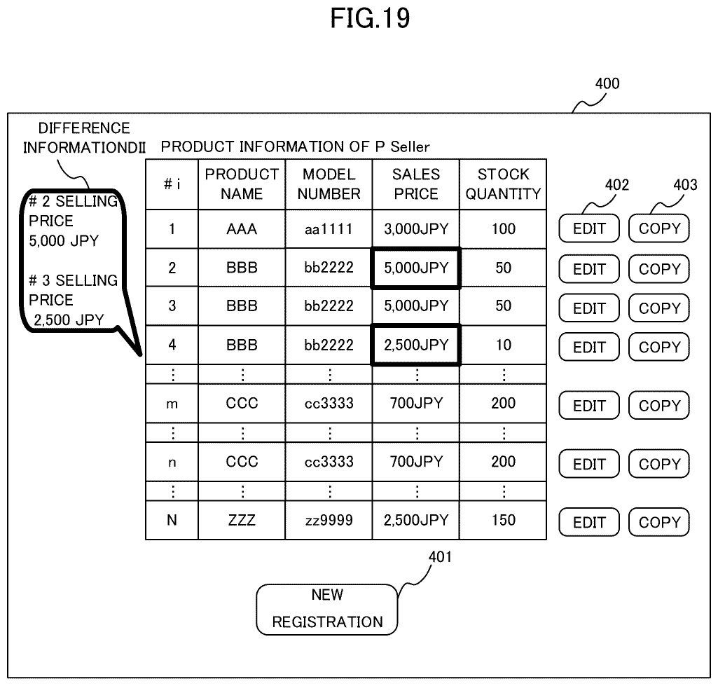

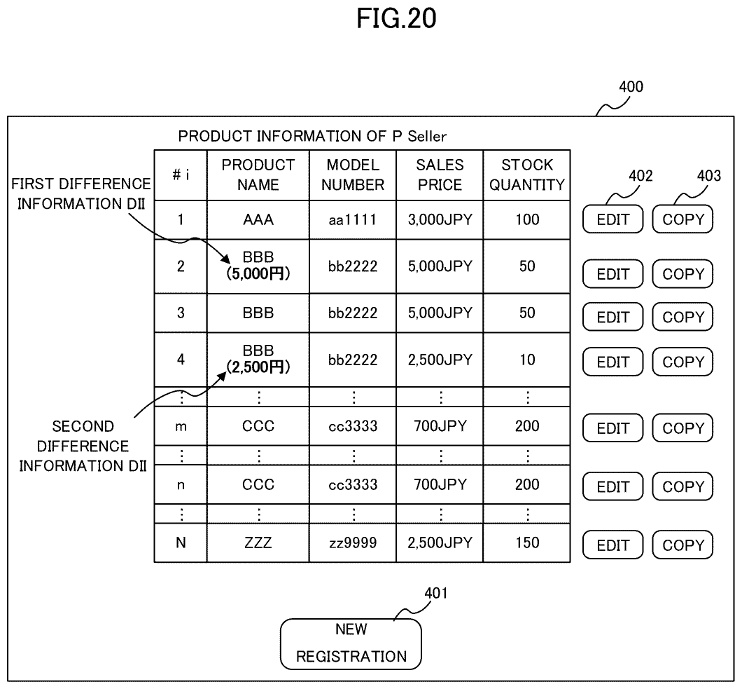

FIG. 19 illustrates an example of the list display screen 400 in the case where information of the selling prices being the difference information DII of the piece of the item information of row number 4 (corresponding to the “second item”) generated by copying the piece of the item information of row number 2 (corresponding to the “first item”) is contained in the reference information RI. The list presenter 130 causes the second difference information DII to be displayed on the left of the product name that is the second piece of the outline information OI corresponding to the second item. The list presenter 130 may cause, as the difference information DII, the selling prices of the piece of the item information of row number 2 and the piece of the item information of row number 4 to be displayed. Furthermore, as illustrated in FIG. 20, the list presenter 130 may cause the difference information DII in the field of the product name, or may cause the first difference information DII to be displayed in the field of the product name of the first item and cause the second difference information DII to be displayed in the field of the product name of the second item. The list presenter 130 may highlight, as the difference information, portions of the selling prices of row number 2 and row number 4. Thereafter, the processing proceeds to step S807. Upon determining that the piece of the item information for which calculation is currently performed is the last piece of the item information, that is, determining that row number i satisfies i=N, (YES in step S807), the product information management server 101 transmits, to the terminal 102, the list present response in which the generated list L is specified, and ends the processing.

As described above, according to the present embodiment, the specifier 140 specifies the different portion in a list of listing multiple pieces of the item information that are the same in basic content and that differ only in some portions, and the list presenter 130 presents this different portion. This configuration allows the user to distinguish items without a special operation, for example, even in the case of items that are not easily distinguishable due to generation through a copy operation.

### Modified Examples

Although the aforementioned embodiment describes an example in which the row number is used as the entry assigned to each record among the entries of the product information records as illustrated in FIG. 3, a record number for identification of a piece of the item information may be used instead of the row number. Although the row number can shift due to addition of a new piece of the item information between rows through a copy operation and the like or deletion of a specific piece of the item information, such shifting due to these operations does not occur in the case of using the record number, since each record number is assigned to the corresponding piece of the item information itself.

Furthermore, although the aforementioned embodiment describes assigning the copy flag “O” to the piece of the item information as the original from which a copy is generated and assigning the copy flag “1” to the piece of the item information as the generated copy, the configuration may be used in which a value of the copy flag increases with an increase in the number of copying. In the case of this configuration, for example, copying a piece of the item information with the copy flag “1” assigned leads to addition, to the list L, of a piece of the item information with the copy flag “2” assigned. This configuration allows the specifier 140 to distinguish the first item and the second item based on a magnitude relation of copy flags and thereby allows the list presenter 130 to present the difference information DII while clarifying a correspondence relationship between the first item and the second item. Furthermore, the copy flag may indicate the record number as the original from which a copy is generated. This configuration allows the list presenter 130 to present the difference information DII while clarifying a correspondence relationship between the first item and the second item.

Furthermore, although the aforementioned embodiment describes an example case of using information of copy flags, the copy state information may contain, in addition to information indicating whether being a copy, information of the original from which a copy is generated. This configuration enables defining a parent-child relationship for each copy of the product information record. Furthermore, information indicating such parent-child relationship for a copy may be output and displayed as the difference information.

Furthermore, although the aforementioned embodiment describes an example case of outputting and displaying the outline information, the reference information, and the difference information, the configuration for only outputting the outline information and the difference information may be used. Furthermore, although the aforementioned embodiment describes causing the list of the product information to be output and displayed, the terminal 102 may simply store the list of the product information without displaying.

### Appendices

### Appendix 1

A product information management server connectable via a network to one or more terminals, the product information management server comprising:
at least one processor,
wherein the at least one processor is configured to
   extract, from a product information registration database in which a plurality of pieces of detailed information each containing a piece of outline information of an item are registered, a plurality of pieces of the outline information,
   when a first piece of the outline information in a first piece of the detailed information corresponding to a first item matches a second piece of the outline information in a second piece of the detailed information corresponding to a second item, specify a different portion that differentiates the first piece of the detailed information and the second piece of the detailed information, and
   output, to at least one terminal of the one or more terminals, second difference information together with a list of listing the extracted plurality of pieces of the outline information, the second difference information being information of the different portion in the second piece of the detailed information.

### Appendix 2

The product information management server according to Appendix 1, wherein
each piece of the detailed information further contains copy state information indicating whether being a piece of information generated by copying, and
the at least one processor is configured to, when specifying with reference to the copy state information that one of two pieces of the detailed information that match in terms of the extracted piece of the outline information is due to a copy of the other of the two pieces the detailed information, use the other as the first piece of the detailed information and use the one as the second piece of the detailed information.

### Appendix 3

The product information management server according to Appendix 1 or 2, wherein
each piece of the detailed information further contains a piece of reference information, and
the at least one processor is configured to
   further extract other predetermined portion of each of the plurality of pieces of the detailed information that are registered in the product information registration database and that correspond to a plurality of the items, and use as the piece of the reference information,
   present the list in which each piece of the outline information is associated with a piece of the reference information extracted from a piece of the detailed information from which the piece of the outline information is extracted, and
   when the second difference information is contained in a second piece of the reference information extracted from the second piece of the detailed information, highlight in the list the second difference information contained in the second piece of the reference information.

### Appendix 4

The product information management server according to Appendix 1 to 3, wherein
the at least one processor is configured to further present, together with the first piece of the outline information listed in the list, first difference information being information of the different portion in the first piece of the detailed information.

### Appendix 5

The product information management server according to Appendix 1 to 4, wherein
the at least one processor is configured to present warning information when the different portion is unspecifiable by the at least one processor.

### Appendix 6

The product information management server according to Appendix 5, wherein
the first piece of the outline information is listed in an m-th position in the list, and the second piece of the outline information is listed in an n-th position in the list,
the at least one processor is configured to, when the different portion is unspecifiable by the at least one processor, present, as the warning information, first warning information together with the first piece of the outline information and second warning information together with the second piece of the outline information,
the first warning information indicates that being identical in content to the item of the n-th position, and
the second warning information indicates that being identical in content to the item of the m-th position.

### Appendix 7

A product information management method, comprising:
by a server computer connected via a network to one or more terminal computers,
extracting, from a product information registration database in which a plurality of pieces of detailed information each containing a piece of outline information of an item are registered, a plurality of pieces of the outline information;
when a first piece of the outline information in a first piece of the detailed information corresponding to a first item matches a second piece of the outline information in a second piece of the detailed information corresponding to a second item, specifying a different portion that differentiates the first piece of the detailed information and the second piece of the detailed information; and
outputting, to at least one terminal computer of the one or more terminal computers, second difference information together with a list of listing the extracted plurality of pieces of the outline information, the second difference information being information of the different portion in the second piece of the detailed information.

### Appendix 8

A non-transitory computer-readable recording medium that stores a program causing a server computer connectable via a network to one or more terminal computers to:
extract, from a product information registration database in which a plurality of pieces of detailed information each containing a piece of outline information of an item are registered, a plurality of pieces of the outline information;
when a first piece of the outline information in a first piece of the detailed information corresponding to a first item matches a second piece of the outline information in a second piece of the detailed information corresponding to a second item, specify a different portion that differentiates the first piece of the detailed information and the second piece of the detailed information; and
output, to at least one terminal computer of the one or more terminal computers, second difference information together with a list of listing the extracted plurality of pieces of the outline information, the second difference information being information of the different portion in the second piece of the detailed information.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can be suitably used for a product information management server, a product information management method, and a recording medium, for presenting multiple items that are the same in basic content and that differ only in some portions in a manner that enables easy distinction of multiple items in a list.

1. A product information management server connectable via a network to one or more terminals, the product information management server comprising:
at least one processor,
wherein the at least one processor is configured to
extract, from a product information registration database in which a plurality of pieces of detailed information each containing a piece of outline information of an item are registered, a plurality of pieces of the outline information,
when a first piece of the outline information in a first piece of the detailed information corresponding to a first item matches a second piece of the outline information in a second piece of the detailed information corresponding to a second item, specify a different portion that differentiates the first piece of the detailed information and the second piece of the detailed information, and
output, to at least one terminal of the one or more terminals, second difference information together with a list of listing the extracted plurality of pieces of the outline information, the second difference information being information of the different portion in the second piece of the detailed information.

2. The product information management server according to claim 1, wherein
each piece of the detailed information further contains copy state information indicating whether being a piece of information generated by copying, and
the at least one processor is configured to, when specifying with reference to the copy state information that one of two pieces of the detailed information that match in terms of the extracted piece of the outline information is due to a copy of the other of the two pieces the detailed information, use the other as the first piece of the detailed information and use the one as the second piece of the detailed information.

3. The product information management server according to claim 1, wherein
each piece of the detailed information further contains a piece of reference information, and
the at least one processor is configured to
further extract other predetermined portion of each of the plurality of pieces of the detailed information that are registered in the product information registration database and that correspond to a plurality of the items, and use as the piece of the reference information,
present the list in which each piece of the outline information is associated with a piece of the reference information extracted from a piece of the detailed information from which the piece of the outline information is extracted, and
when the second difference information is contained in a second piece of the reference information extracted from the second piece of the detailed information, highlight in the list the second difference information contained in the second piece of the reference information.

4. The product information management server according to claim 1, wherein
the at least one processor is configured to further present, together with the first piece of the outline information listed in the list, first difference information being information of the different portion in the first piece of the detailed information.

5. The product information management server according to claim 1, wherein
the at least one processor is configured to present warning information when the different portion is unspecifiable by the at least one processor.

6. The product information management server according to claim 5, wherein
the first piece of the outline information is listed in an m-th position in the list, and the second piece of the outline information is listed in an n-th position in the list,
the at least one processor is configured to, when the different portion is unspecifiable by the at least one processor, present, as the warning information, first warning information together with the first piece of the outline information and second warning information together with the second piece of the outline information,
the first warning information indicates that being identical in content to the item of the n-th position, and
the second warning information indicates that being identical in content to the item of the m-th position.

7. A product information management method, comprising:
by a server computer connected via a network to one or more terminal computers,
extracting, from a product information registration database in which a plurality of pieces of detailed information each containing a piece of outline information of an item are registered, a plurality of pieces of the outline information;
when a first piece of the outline information in a first piece of the detailed information corresponding to a first item matches a second piece of the outline information in a second piece of the detailed information corresponding to a second item, specifying a different portion that differentiates the first piece of the detailed information and the second piece of the detailed information; and
outputting, to at least one terminal computer of the one or more terminal computers, second difference information together with a list of listing the extracted plurality of pieces of the outline information, the second difference information being information of the different portion in the second piece of the detailed information.

8. A non-transitory computer-readable recording medium that stores a program causing a server computer connectable via a network to one or more terminal computers to:
extract, from a product information registration database in which a plurality of pieces of detailed information each containing a piece of outline information of an item are registered, a plurality of pieces of the outline information;
when a first piece of the outline information in a first piece of the detailed information corresponding to a first item matches a second piece of the outline information in a second piece of the detailed information corresponding to a second item, specify a different portion that differentiates the first piece of the detailed information and the second piece of the detailed information; and
output, to at least one terminal computer of the one or more terminal computers, second difference information together with a list of listing the extracted plurality of pieces of the outline information, the second difference information being information of the different portion in the second piece of the detailed information.
